(19) United States
(12) Patent Application Publication
(10) Pub. No.: US 2016/0314894 A1
(43) Pub. Date: Oct. 27, 2016

(54) MAGNETIC PART AND ELECTRIC CIRCUIT

(71) Applicant: Panasonic Intellectual Property Management Co., Ltd., Osaka (JP)

(72) Inventors: TAIKI NISHIMOTO, Osaka (JP); AKIRA MINEGISHI, Osaka (JP); SHOICHI HARA, Osaka (JP)

(21) Appl. No.: 15/016,387

(22) Filed: Feb. 5, 2016

(30) Foreign Application Priority Data
Apr. 23, 2015 (JP) 2015-088010

(51) Int. Cl. H01F 27/28

(52) U.S. Cl. CPC H01F 27/2823

(57) ABSTRACT

A magnetic part includes: a magnetic core; a first winding; a second winding that is not short-circuited with the first winding; and a third winding, wherein the first winding, the second winding, and the third winding are wound around the magnetic core, a first magnetic flux is generated in the magnetic core by a first electric current flowing through the first winding, a second magnetic flux is generated in the magnetic core by a second electric current flowing through the second winding in a direction same as the first electric current, a third magnetic flux is generated in the magnetic core by a third electric current flowing through the third winding in a direction reverse to the first electric current, and the first magnetic flux, the second magnetic flux, and the third magnetic flux strengthen one another.

### BACKGROUND

1. Technical Field

The present disclosure relates to a noise suppression part that removes common mode noise.

2. Description of the Related Art

Japanese Unexamined Patent Application Publication No. 6-233521 discloses a noise filter circuit that includes a choke coil and a ground line choke coil.

Japanese Unexamined Patent Application Publication No. 10-303674 discloses an AC line filter having an electric current supply circuit that supplies electromotive force to a common mode choke coil in accordance with output of a noise amplifying circuit.

In the conventional arts, a reduction of the size of a structure for common mode noise suppression is desired.

### SUMMARY

In one general aspect, the techniques disclosed here feature a magnetic part includes: a magnetic core; a first winding; a second winding that is not short-circuited with the first winding; and a third winding. The first winding, the second winding, and the third winding are wound around the magnetic core. A first magnetic flux is generated in the magnetic core by a first electric current flowing through the first winding. A second magnetic flux is generated in the magnetic core by a second electric current flowing through the second winding in a direction same as the first electric current. A third magnetic flux is generated in the magnetic core by a third electric current flowing through the third winding in a direction reverse to the first electric current. The first magnetic flux, the second magnetic flux, and the third magnetic flux strengthen one another.

According to the present disclosure, it is possible to reduce the size of a structure for common mode noise suppression.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram illustrating an outline configuration of a magnetic part of Embodiment 1;

FIG. 2 is a diagram illustrating an outline configuration of a modification of the magnetic part of Embodiment 1;

FIG. 3 is a diagram illustrating an outline configuration of another modification of the magnetic part of Embodiment 1;

FIG. 4 is a diagram illustrating an outline configuration of an example of an electric circuit of Embodiment 2;

FIG. 5 is a diagram illustrating an example of measurement of transmission characteristics in a common mode;

FIG. 6 is a diagram illustrating an outline configuration of a common mode choke coil; and

FIG. 7 is a diagram illustrating an example of a noise filter circuit in a single-phase three-line system.

### DETAILED DESCRIPTION

Embodiments of the present disclosure are described below with reference to the drawings.

First, points on which the inventor of the present invention focused are described below.

A noise filter circuit is used for removal of noise that flows out from a circuit device through a power-supply line or as a measure against incoming noise. Noise is classified into normal mode noise and common mode noise depending on propagation characteristics thereof. The normal mode noise is noise that travels between electric power lines. The common mode noise is noise that propagates on a plurality of electric power lines in the same phase and returns on a neutral line in a reverse phase.

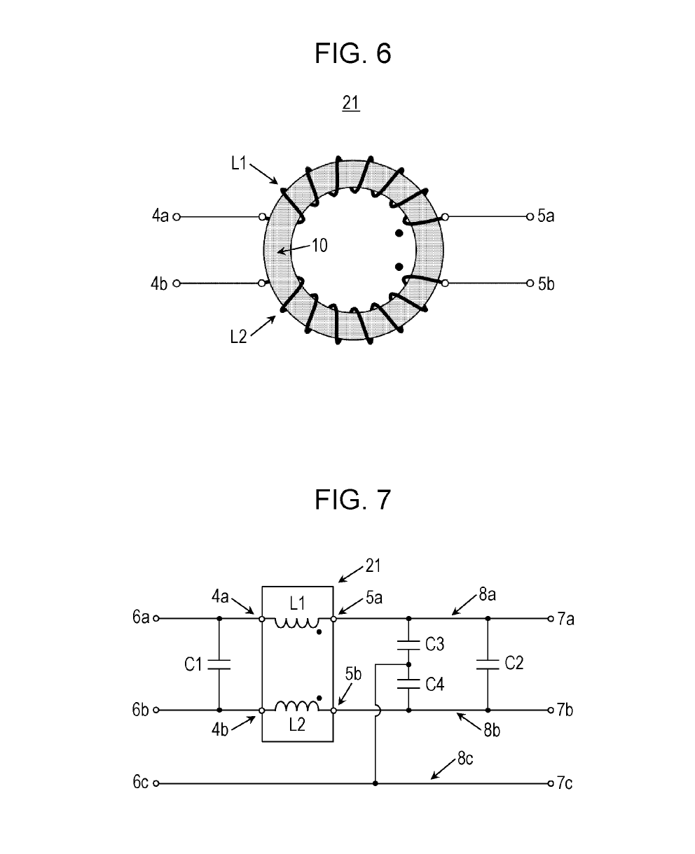

FIG. 6 is a diagram illustrating an outline configuration of a common mode choke coil 21.

FIG. 7 is a diagram illustrating an example of a noise filter circuit in a single-phase three-line system.

A capacitor C3 and a capacitor C4 for reducing common mode noise are connected among a first electric power line 8a, a second electric power line 8b, and a neutral line 8c. A common mode choke coil 21 is connected on a side closer to a power supply than the capacitor C3 and the capacitor C4.

Part of an electric current that is supplied from the power-supply side leaks to the neutral line 8c via the capacitor C3 and the capacitor C4. An upper limit of a leak electric current is defined in a safety standard. In view of this, capacitors having low capacity of several nF or lower are used as the capacitor C3 and the capacitor C4. Parameters that attenuate the common mode noise is the capacitances of the capacitor C3 and the capacitor C4 and the inductance of the common mode choke coil 21. Accordingly, in order to sufficiently reduce the common mode noise, the inductances of a first winding L1 and a second winding L2 of the common mode choke coil 21 need be made large.

However, in a circuit that handles electric power of the order of kW, a large electric current of approximately several A to several tens of A flows through the first electric power line 8a and the second electric power line 8b. This makes it necessary to wind thick electric lines having a large electric current capacity as the first winding L1 and the second winding L2 that are connected into the first electric power line 8a and the second electric power line 8b, respectively. However, there is a problem that the volume of the common mode choke coil 21 increases in a case where the number of turns of the first winding L1 or the second winding L2 is increased.

Based on the points described above, the inventor of the present invention accomplished the following embodiments.

### Embodiment 1

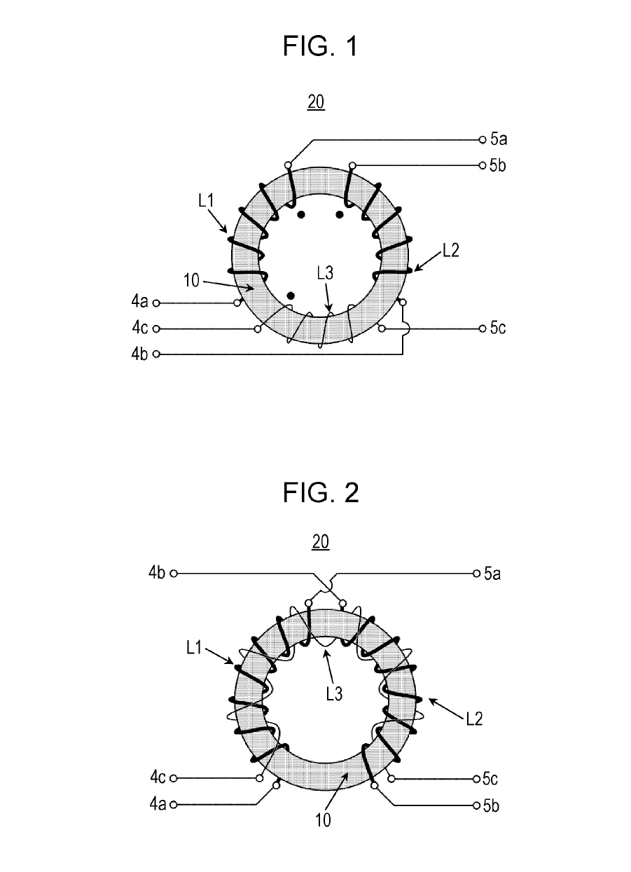

FIG. 1 is a diagram illustrating an outline configuration of a magnetic part of Embodiment 1.

In FIG. 1, the black circles illustrated beside windings indicate directions of magnetic coupling of the windings.

The magnetic part of Embodiment 1 includes a magnetic core 10, a first winding L1, a second winding L2, and a third winding L3. The second winding L2 is not short-circuited with the first winding L1.

The first winding L1, the second winding L2, and the third winding L3 are wound around the magnetic core 10.

A first electric current flows through the first winding L1. This generates a first magnetic flux in the magnetic core 10.

A second electric current flows through the second winding L2 in the direction same as the first electric current. This generates a second magnetic flux in the magnetic core 10.

A third electric current flows through the third winding L3 in a direction reverse to the first electric current. This generates a third magnetic flux in the magnetic core 10.

The first magnetic flux, the second magnetic flux, and the third magnetic flux strengthen one another.

According to this arrangement, the size of a structure for common mode noise suppression can be reduced. That is, according to the above arrangement, in a case where common mode noise that flows a first winding and a second winding in the same phase and returns through a third winding in a reverse phase occur, all of the windings generate magnetic fluxes of the same direction in the magnetic core. That is, for example, in a case where a common mode choke coil is produced by using this magnetic part, magnetic fluxes that occur due to common mode noise flow through electric power lines and a neutral line of an electric circuit can be coupled so as to strengthen each other. This makes it possible to obtain large impedance in the case of occurrence of common mode noise even in a case where the inductances of the first winding and the second winding are small. That is, the inductance of each winding can be small. This makes it possible to reduce the number of turns of the first winding and the second winding (e.g., thick windings connected into electric power lines), thereby achieving a reduction in the size of the common mode choke coil.

For example, assume that the magnetic part of Embodiment 1 is produced by using a magnetic core of a toroidal shape (it is assumed that the number of turns of the first winding, the number of turns of the second winding, and the number of turns of the third winding are the same). In this magnetic part, the volume of the magnetic core can be made smaller by approximately 75% than that in a conventional toroidally-shaped two-line common mode choke coil. Furthermore, in this magnetic part, the volume of the magnetic core can be made smaller by approximately 50% than that in an arrangement in which an inductor that is not coupled with a conventional toroidally-shaped two-line common mode choke is inserted into a neutral line in addition to the conventional toroidally-shaped two-line common mode choke coil.

According to the above arrangement, it is possible to suppress an increase in the number of parts such as addition of a ground line choke coil as disclosed in Japanese Unexamined Patent Application Publication No. 6-233521. As a result, it is possible to suppress a decrease in reliability of a circuit caused by an increase in the number of parts. Furthermore, it is possible to suppress an increase in the number of steps in design and mounting processes caused by an increase in the number of parts.

According to the above arrangement, it is possible to make the circuit scale smaller than that in an arrangement in which a power-supply system for noise suppression as disclosed in Japanese Unexamined Patent Application Publication No. 10-303674 is additionally provided.

According to the above arrangement, the self-resonant frequency of the common mode choke coil increases because the inductance of each winding is small. This makes it possible to widen a frequency band in which the common mode choke coil effectively functions.

According to the above arrangement, the length of the first winding and the length of the second winding become shorter. This keeps resistance components of the first winding and the second winding low. As a result, it is possible to reduce an electric power loss in the magnetic part.

In the configuration illustrated in FIG. 1, for example, the windings are coupled so that the first winding L1 and the second winding L2 generates magnetic fluxes in the same direction and the third winding L3 generates a magnetic flux in a reverse direction in response to an in-phase current supplied from a terminal 5a, a terminal 5b, and a terminal 5c.

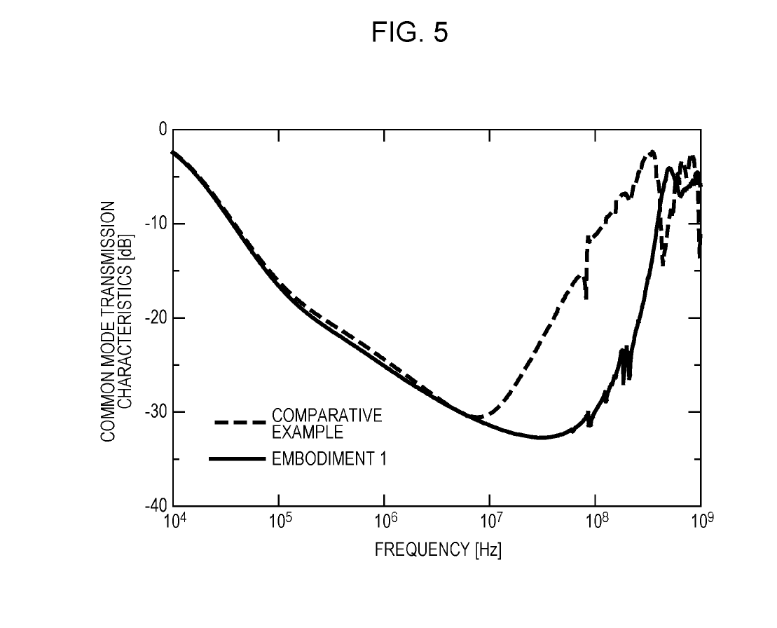

FIG. 5 is a diagram illustrating an example of actual measurement of transmission characteristics in a common mode.

In FIG. 5, the capability of blocking common mode noise is higher as the value of transmission characteristics is smaller.

In FIG. 5, the solid line represents a result obtained in a case where the magnetic part of Embodiment 1 was used.

A magnetic part in which the number of turns of each of first, second and third windings is 6 was used as the magnetic part of Embodiment 1.

An enamel wire having a diameter of 0.5 mm was used as the third winding in the magnetic part of Embodiment 1.

In FIG. 5, the broken line represents a result obtained in a case where a magnetic part of a comparative example was used.

As the comparative example, a two-line common mode choke coil as illustrated in FIG. 6 was used. The number of turns of each of first and second windings was 12.

In the magnetic part of Embodiment 1 and the magnetic part of the comparative example, enamel wires having a diameter of 1.6 mm were used as the first winding and the second winding.

In the magnetic part of Embodiment 1 and the magnetic part of the comparative example, a core that is made of a nano-crystalline soft magnetic material and that has a cross-sectional area of 23 mm² and an outer periphery outer diameter of 27.5 mm was used as a magnetic core.

FIG. 5 is a result of measurement obtained by a network analyzer in a case where output power was 1 mW.

As illustrated in FIG. 5, the magnetic part of Embodiment 1 in which the number of turns is smaller can achieve common mode noise blocking performance equal to or higher than that of the comparative example in which the number of turns is larger.

As described above, it is possible to achieve a reduction in the size of the single part, i.e., the common mode choke coil while maintaining a common mode noise reduction effect.

In the magnetic part of Embodiment 1, the diameter of the third winding L3 may be smaller than at least one of the diameter of the first winding L1 and the diameter of the second winding L2. For example, the diameter of the third winding L3 may be smaller than both of the diameter of the first winding L1 and the diameter of the second winding L2.

According to this arrangement, for example, a third winding formed with a conductive wire having a small diameter can be wound around a small section of the outer periphery of the magnetic core. That is, the size of the magnetic part can be further reduced by making the diameter of the third winding smaller. In a case where the third winding is connected to a neutral line, a minute electric current flows through the third winding as common mode noise. Therefore, a thin wire that has a small electric current capacity can be used as the third winding.

FIG. 2 is a diagram illustrating an outline configuration of a modification of the magnetic part of Embodiment 1.

In the magnetic part of Embodiment 1, the third winding L3 may be wound around a part around which at least one of the first winding L1 and the second winding L2 has been wound. For example, in the magnetic part of Embodiment 1, the third winding L3 may be wound around a part around which the first winding L1 and the second winding L2 have been wound as illustrated in FIG. 2.

According to this arrangement, a magnetic core having a region necessary for winding of only a first winding and a second winding can be used. That is, since a region necessary for winding of a third winding becomes unnecessary, the size of the magnetic core can be further reduced. In order to prevent magnetic flux saturation caused by a normal mode electric current, it is preferable that the coefficient of coupling between the first winding and the second winding be a value close to 1. Meanwhile, a reduction of a coefficient of coupling between the first winding and the third winding and a coefficient of coupling between the second winding and the third winding does not cause magnetic flux saturation.

According to the arrangement, it is possible to reduce the parasitic capacitance between each adjacent turn of the first winding and second winding. Furthermore, it is possible to increase the parasitic capacitance between the first winding and the third winding and the parasitic capacitance between the second winding and the third winding. This makes it possible to further increase the self-resonant frequency of the common mode choke coil using the magnetic part. Furthermore, it is possible to further improve the effect of reducing common mode noise.

Note that in the example of the configuration illustrated in FIG. 2, the first winding L1 and the second winding L2 need be insulated from the third winding L3. For example, the third winding L3 may be covered with an insulating film. Alternatively, at least one of the first winding L1 and the second winding L2 may be covered with an insulating film. Alternatively, the first winding L1 and the second winding L2 may be separated from the third winding L3 by an insulating partition.

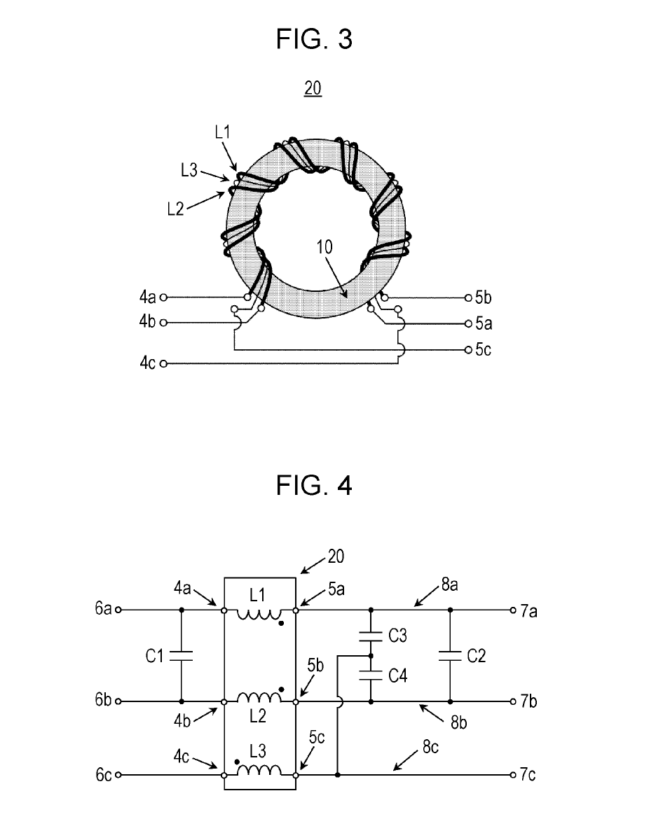

FIG. 3 is a diagram illustrating an outline configuration of another modification of the magnetic part of Embodiment1.

In the magnetic part of Embodiment 1, the third winding L3 may be wound between turns of the first winding L1 and the second winding L2 as illustrated in FIG. 3.

According to this arrangement, it is possible to further reduce the parasitic capacitance between each adjacent turn of the first winding and second winding. Furthermore, it is possible to further increase the parasitic capacitance between the first winding and the third winding and the parasitic capacitance between the second winding and the third winding. This makes it possible to further increase the self-resonant frequency of the common mode choke coil using the magnetic part. Furthermore, it is possible to further improve the effect of reducing common mode noise.

In the magnetic part of Embodiment 1, the number of turns of the first winding L1 may be equal to the number of turns of the second winding L2. In this case, the number of turns of the third winding L3 may be different from the number of turns of the first winding L1.

According to this arrangement, since the number of turns of the first winding is equal to the number of turns of the second winding, it is possible to prevent magnetic flux saturation caused by a normal mode electric current. In this case, a desired common mode impedance can be set by adjusting the number of turns of the third winding that does not affect magnetic flux saturation.

In the magnetic part of Embodiment 1, a terminal of the first winding L1 to which the first electric current is input, a terminal of the second winding L2 to which the second electric current is input, and a terminal of the third winding L3 to which the third electric current is output may be disposed on one side.

In this case, a terminal of the first winding L1 from which the first electric current is output, a terminal of the second winding L2 from which the second electric current is output, and a terminal of the third winding L3 from which the third electric current is input may be disposed on another side.

According to this arrangement, for example, a circuit-side terminal that is a noise source can be separated from a power-supply-side terminal. This makes it possible to keep the parasitic capacitance between the terminals low. It is therefore possible to suppress occurrence of a parasitic capacitance that is parallel with the inductance of the winding. This makes it possible to suppress a decrease in the noise reduction effect of the common mode choke coil.

In the exemplary configurations illustrated in FIGS. 1, 2, and 3, a terminal 4a, a terminal 4b, and a terminal 4c are disposed away from a terminal 5a, a terminal 5b, and a terminal 5c.

In the magnetic part of Embodiment 1, a fourth electric current may flow through the first winding L1 in a direction reverse to the first electric current. This generates a fourth magnetic flux in the magnetic core 10.

In this case, a fifth electric current may flow through second winding L2 in a direction reverse to the fourth electric current. This generates a fifth magnetic flux in the magnetic core 10.

In this case, the fourth magnetic flux and the fifth magnetic flux may weaken each other.

According to this arrangement, it is possible to prevent flow of the normal mode electric current from being inhibited by the magnetic part.

Each winding may be a winding made of a known material such as a copper line.

The magnetic core 10 may be a magnetic core made of a known material such as a ferrite core.

The magnetic core 10 may have a gap on a magnetic path thereof.

According to this arrangement, it is possible to further suppress occurrence of magnetic saturation of the magnetic core even in a case where there is a large variation in inductance because of the small number of turns of the first winding and second winding.

The magnetic core 10 may be a complex core combining a plurality of core members.

According to this arrangement, for example, a magnetic core having a high magnetic permeability at a low frequency and a magnetic core having a high magnetic permeability at a high frequency can be combined. This increases the self-resonant frequency of the magnetic part, thereby achieving high-frequency characteristics.

### Embodiment 2

Embodiment 2 is described below. Description that overlaps the description in Embodiment 1 is omitted as appropriate.

FIG. 4 is a diagram illustrating an example of an outline configuration of an electric circuit of Embodiment 2.

The electric circuit of Embodiment 2 includes a magnetic part 20, a first electric power line 8a, a second electric power line 8b, and a neutral line 8c. The second electric power line 8b is not short-circuited with the first electric power line 8a.

The magnetic part 20 is the magnetic part of Embodiment 1.

A first winding L1 of the magnetic part 20 is connected to the first electric power line 8a.

A second winding L2 of the magnetic part 20 is connected to the second electric power line 8b.

A third winding L3 of the magnetic part 20 is connected to the neutral line 8c.

According to this arrangement, it is possible to reduce the size of a structure for common mode noise suppression in the electric circuit.

For example, common mode noise that occurs due to parasitic coupling with neutral electric potential is large in a switching power supply circuit. It is possible to effectively reduce common mode noise without remarkably increasing the circuit scale, for example, by inserting, as a common mode choke coil, the magnetic part of Embodiment 1 to an input side of the switching power supply circuit.

The effects described in Embodiment 1 can be produced by using the magnetic part of Embodiment 1.

More specifically, in the electric circuit of Embodiment 2, the flow of electric currents and magnetic fluxes described below occur when a common mode electric current flows through the first electric power line 8a and the second electric power line 8b.

That is, a first electric current flows through the first winding L1. This generates a first magnetic flux in the magnetic core 10 of the magnetic part 20.

Furthermore, a second electric current flows through the second winding L2 in the same direction as the first electric current. This generates a second magnetic flux in the magnetic core 10 of the magnetic part 20.

Furthermore, a return current flows through the neutral line 8c in a direction reverse to the common mode electric current. This causes a third electric current to flow through the third winding L3 in a direction reverse to the first electric current. This generates a third magnetic flux in the magnetic core 10 of the magnetic part 20.

In this case, the first magnetic flux, the second magnetic flux, and the third magnetic flux strengthen one another.

According to this arrangement, the impedance of the magnetic part 20 increases when the common mode electric current flows. This inhibits the flow of the common mode electric current. As a result, common mode noise in the electric circuit can be reduced.

More specifically, in the electric circuit of Embodiment 2, flow of electric currents and magnetic fluxes described below occur when a normal mode electric current flows through the first electric power line 8a and the second electric power line 8b.

That is, a fourth electric current flows through the first winding L1. This generates a fourth magnetic flux in the magnetic core 10 of the magnetic part 20.

Furthermore, a fifth electric current flows through the second winding L2 in a direction reverse to the fourth electric current. This generates a fifth magnetic flux in the magnetic core 10 of the magnetic part 20.

The fourth magnetic flux and the fifth magnetic flux weaken each other.

According to this arrangement, the impedance of the magnetic part 20 decreases when the normal mode electric current flows. This makes it possible to prevent the flow of the normal mode electric current in the electric circuit from being inhibited by the magnetic part 20.

In the exemplary configuration illustrated in FIG. 4, a capacitor C1 and a capacitor C2 are provided. This makes it possible to reduce normal mode noise.

In the exemplary configuration illustrated in FIG. 4, a capacitor C3 and a capacitor C4 are provided. This makes it possible to reduce common mode noise.

As described above, in the exemplary configuration illustrated in FIG. 4, the magnetic part 20 and the capacitors C1 through C4 constitute a noise filter circuit.

Note that the electric circuit of Embodiment 2 may be an electric circuit that is connected to a single-phase three-line system power-supply line and a power-supply circuit.

A power-supply wire of the power-supply circuit is connected to a terminal 7a and a terminal 7b. A neutral electric potential of the power-supply circuit is connected to a terminal 7c. A power-supply wire of the power-supply cable is connected to a terminal 6a and a terminal 6b. A neutral line of the power-supply cable is connected to a terminal 6c.

The above connection makes it possible to markedly attenuates common mode noise that flows from the terminal 7a and the terminal 7b and returns from the terminal 7c.

Note that the position of the magnetic part 20, the positions of the capacitors C1 and C2, and the positions of the capacitors C3 and C4 may be interchanged with one another.

A multi-stage circuit may be provided by using two or more magnetic parts 20.

A magnetic part of the present disclosure is applicable as a noise filter in a switching power-supply circuit or the like.

While the present disclosure has been described with respect to exemplary embodiments thereof, it will be apparent to those skilled in the art that the disclosure may be modified in numerous ways and may assume many embodiments other than those specifically described above. Accordingly, it is intended by the appended claims to cover all modifications of the disclosure that fall within the true spirit and scope of the disclosure.

What is claimed is:

1. A magnetic part comprising:
a magnetic core;
a first winding;
a second winding that is not short-circuited with the first winding; and
a third winding,
wherein the first winding, the second winding, and the third winding are wound around the magnetic core,
a first magnetic flux is generated in the magnetic core by a first electric current flowing through the first winding,
a second magnetic flux is generated in the magnetic core by a second electric current flowing through the second winding in a direction same as the first electric current,
a third magnetic flux is generated in the magnetic core by a third electric current flowing through the third winding in a direction reverse to the first electric current, and
the first magnetic flux, the second magnetic flux, and the third magnetic flux strengthen one another.

2. The magnetic part according to claim 1, wherein
a diameter of the third winding is smaller than at least one of a diameter of the first winding and a diameter of the second winding.

3. The magnetic part according to claim 1, wherein
the third winding is wound around a part around which at least one of the first winding and the second winding is wound.

4. The magnetic part according to claim 1, wherein
the third winding is wound between turns of the first winding and the second winding.

5. The magnetic part according to claim 1, wherein
the number of turns of the first winding is equal to the number of turns of the second winding; and
the number of turns of the third winding is different from the number of turns of the first winding.

6. The magnetic part according to claim 1, wherein
a terminal of the first winding to which the first electric current is input, a terminal of the second winding to which the second electric current is input, and a terminal of the third winding to which the third electric current is output are disposed on one side; and
a terminal of the first winding from which the first electric current is output, a terminal of the second winding from which the second electric current is output, and a terminal of the third winding from which the third electric current is input are disposed on another side.

7. The magnetic part according to claim 1, wherein
a fourth magnetic flux is generated in the magnetic core by a fourth electric current flowing through the first winding in a direction reverse to the first electric current;
a fifth magnetic flux is generated in the magnetic core by a fifth electric current flowing through the second winding in a direction reverse to the fourth electric current; and
the fourth magnetic flux and the fifth magnetic flux weaken each other.

8. An electric circuit comprising:
a magnetic part according to claim 1;
a first electric power line;
a second electric power line; and
a neutral line,
wherein the first winding is connected to the first electric power line,
the second winding is connected to the second electric power line, and
the third winding is connected to the neutral line.

9. The electric circuit according to claim 8, wherein
when a common mode electric current flows through the first electric power line and the second electric power line, the first electric current flows through the first winding, the second electric current flows through the second winding, and a return current flows through the neutral line in a direction reverse to the common mode electric current, which causes the third electric current to flow through the third winding.

10. The electric circuit according to claim 8, wherein
when a normal mode electric current flows through the first electric power line and the second electric power line, a fourth electric current flows through the first winding, and a fifth electric current flows through the second winding in a direction reverse to the fourth electric current,
a fourth magnetic flux is generated in the magnetic core by the fourth electric current flowing through the first winding;
a fifth magnetic flux is generated in the magnetic core by the fifth electric current flowing through the second winding; and
the fourth magnetic flux and the fifth magnetic flux weaken each other.
